(19) United States
(12) Patent Application Publication
(10) Pub. No.: US 2023/0301246 A1
(43) Pub. Date: Sep. 28, 2023

(54) INFORMATION PROCESSING DEVICE AND INFORMATION PROCESSING SYSTEM

(71) Applicant: Bayer CropScience K.K., Tokyo (JP)

(72) Inventor: Satoshi ITO, Tokyo (JP)

(21) Appl. No.: 18/023,311

(22) PCT Filed: Aug. 20, 2021
(86) PCT No.: PCT/JP2021/030665

§ 371 Date: Feb. 24, 2023

(30) Foreign Application Priority Data
Aug. 31, 2020 (JP) 2020-145145

(51) Int. Cl. A01G 9/24; G06N 20/00

(52) U.S. Cl. CPC A01G 9/24; G06N 20/00

(57) ABSTRACT

[Summary] [Problem] To improve accuracy in relation to predicting the future environment inside a greenhouse. [Solution] An information processing device (100) is provided with: an extra-atmospheric solar irradiance calculating unit (140) for calculating the extra-atmospheric solar irradiance in each time span on each date at an installation location of a greenhouse (3A, 3B) in which a crop is cultivated; a machine learning unit (131) for performing machine learning of a greenhouse environment prediction model on the basis of actual result information relating to the environment inside the greenhouse (3A, 3B), using the extra-atmospheric solar irradiance and meteorological predicted information as inputs; a predicting unit (132) for predicting the environment in the greenhouse (3A, 3B) using the greenhouse environment prediction model; and an output control unit (133) for controlling the output of predicted information relating to the predicted environment inside the greenhouse (3A, 3B).

### TECHNICAL FIELD

The present invention relates to an information processing device and an information processing system.

### BACKGROUND ART

Cultivating crops without exterminating pests that break out in the crop causes problems such as a reduction in yield and quality, and farmers are therefore required to predict pest outbreaks and exterminate pests. Furthermore, in recent years, techniques have been established for predicting pest outbreak periods.

For example, patent literature article 1 discloses a technique with which it is possible to notify a farm worker of a pest outbreak period by acquiring future environmental information from meteorological information, and predicting the degree of growth of pests from the environment information.

### CITATION LIST

### Patent Literature

[PTL 1] JP 2016-184232 A

### SUMMARY OF INVENTION

### Problem to Be Solved by the Invention

However, the information accuracy of meteorological predicted information such as weather forecasts deteriorates as the date and time for which the prediction is being carried out moves further into the future. In particular, with regard to solar irradiance included in meteorological information, errors may arise depending on the cloud type (such as cirrus, altocumulus, cumulus), giving rise to the problem that it is difficult to obtain an accurate prediction of the solar irradiance.

Accordingly, the present invention takes account of these problems, and the objective of the present invention is to improve the prediction accuracy of environmental information necessary for cultivating crops in an open field or in a greenhouse, and to provide highly accurate predicted information.

### Solution to Problem

In order to resolve the abovementioned problem, one aspect of the present invention provides an information processing device or an information processing system provided with: an extra-atmospheric solar irradiance calculating unit for calculating the extra-atmospheric solar irradiance in each time span on each date at an installation location of a greenhouse in which a crop is cultivated; a machine learning unit for performing machine learning of a greenhouse environment prediction model on the basis of actual result information relating to the environment inside the greenhouse, using the extra-atmospheric solar irradiance and meteorological predicted information as inputs; a predicting unit for predicting the environment in the greenhouse using the greenhouse environment prediction model; and an output control unit for controlling the output of predicted information relating to the predicted environment inside the greenhouse.

Further, in order to resolve the abovementioned problem, another aspect of the present invention provides an information processing device or an information processing system provided with: an extra-atmospheric solar irradiance calculating unit for calculating the extra-atmospheric solar irradiance in each time span on each date in an open field in which a crop is cultivated; a machine learning unit for performing machine learning of an open-field environment prediction model on the basis of actual result information relating to the environment in the open field, using the extra-atmospheric solar irradiance and meteorological predicted information as inputs; a predicting unit for predicting the environment in the open field using the open-field environment 4prediction model; and an output control unit for controlling the output of predicted information relating to the predicted environment in the open field.

### Advantageous Effects of Invention

According to the present invention as described hereinabove, accuracy in predicting the future environment inside a greenhouse or in an open field can be improved while suppressing costs.

### BRIEF DESCRIPTION OF DRAWINGS

FIG. 1 is a drawing used to describe, in summary, an information processing device or an information processing system according to one embodiment of the present invention.

FIG. 2 is a block diagram illustrating a schematic example of the functional configuration of the information processing device or the information processing system in the same embodiment.

FIG. 3 is a flowchart that conceptually illustrates an example of machine learning processing in an information processing server according to the same embodiment.

FIG. 4 is a flowchart that conceptually illustrates an example of prediction processing in the information processing server according to the same embodiment.

### DESCRIPTION OF EMBODIMENT

A preferred embodiment of the present invention will now be described in detail with reference to the accompanying drawings. It should be noted that in this specification and the figures, duplicate descriptions are omitted by using the same reference signs to denote constituent elements having substantially the same functional configuration.

### 1. Summary

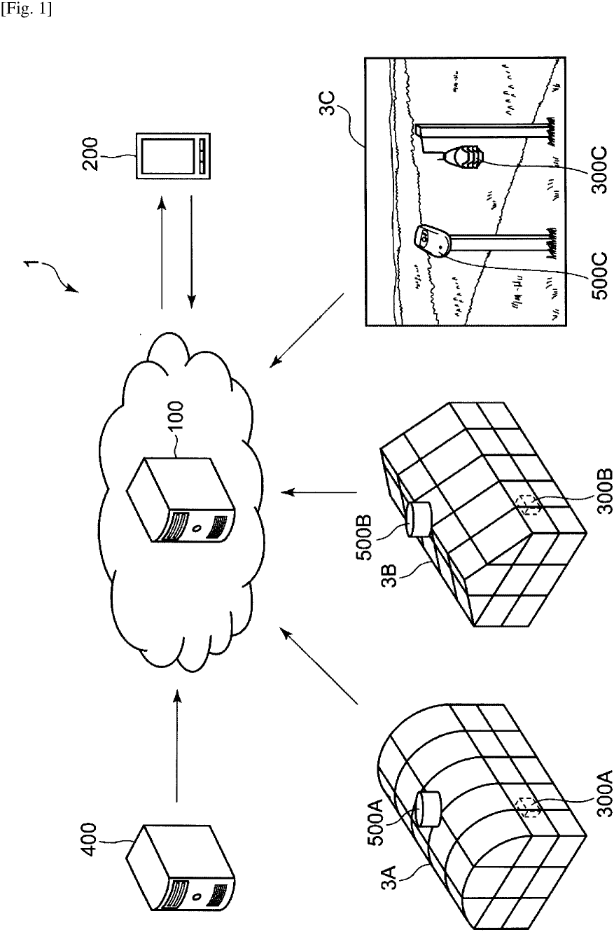

A summary of an information processing system 1 according to an embodiment of the present invention will first be described with reference to FIG. 1. FIG. 1 is a drawing used to describe, in summary, the information processing system 1 according to one embodiment of the present invention.

The information processing system 1 has a collecting function for collecting meteorological information and information relating to the environment inside a greenhouse or in an open field, for example, and the function of predicting the environment inside the greenhouse or in the open field on the basis of the collected information. Further, the information processing system 1 may also have a presenting function for presenting predicted information obtained by means of the predicting function.

More specifically, the information processing system 1 is provided with: an information processing server 100 having an information collecting function and an information distributing function; an information processing terminal 200 having an information viewing function and an information inputting function; and measurement and control devices 300 (300A to 300C) which are provided respectively in greenhouses 3A and 3B and in an open field 3C, and which have an observation function and an observed information distributing function.

It should be noted that the following exemplary embodiment describes the information collecting function relating to the environment inside the greenhouse, and the predicting function relating to the environment inside the greenhouse, but the present invention can also be applied to open-field cultivation, by replacing the greenhouse environment prediction model with an open-field environment prediction model.

An extra-atmospheric solar irradiance calculating unit 140 provided in the information processing server 100 calculates the extra-atmospheric solar irradiance in each time span on each date at the installation locations of the greenhouses 3A and 3B, on the basis of position information relating to the greenhouses 3A and 3B. A storage unit 120 accumulates the calculated extra-atmospheric solar irradiance in each time span on each date. The position information relating to the installation locations of the greenhouses 3A and 3B can be found as a latitude and a longitude, from the address of the installation location. The position information can also be obtained from GPS terminals 500A and 500B installed in the greenhouses 3A and 3B. The position information need not be the exact latitude and longitude of the greenhouses 3A and 3B, and may alternatively be a latitude and a longitude found from a location representative of the city, ward, town, or village in which the greenhouses 3A and 3B are situated, such as the location of a government building. Alternatively, if the latitude and longitude of the greenhouses 3A and 3B are known in advance, the latitude and longitude of the greenhouses 3A and 3B may be input into the information processing terminal 200 and transferred to an information server.

As described above, the information processing server 100 collects the position information of the greenhouses 3A and 3B from the GPS terminals 500A and 500B, or from the information processing terminal 200, and collects the meteorological information (including meteorological predicted information) from a meteorological information server 400. Here, meteorological predicted information means unobserved meteorological information in the future, such as a weather forecast. Furthermore, the information processing server 100 inputs the extra-atmospheric solar irradiance calculated by the extra-atmospheric solar irradiance calculating unit 140 on the basis of the position information, and the collected meteorological information into the greenhouse environment prediction model. Next, the information processing server 100 outputs predicted information relating to the future environment inside the greenhouses 3, output from the greenhouse environment prediction model, and distributes the same to the information processing terminal 200.

In addition, the information processing server 100 employs the greenhouse environment prediction model which has been subjected to machine learning. This machine learning is performed on the basis of actual result information relating to the environment inside the greenhouse, using at least the extra-atmospheric solar irradiance and meteorological observation information as inputs. Here, meteorological observation information means meteorological information observed in the past, such as past weather.

The information processing server 100 may, for example, have a machine learning function. More specifically, the information processing server 100 acquires actual result information relating to the environment inside the greenhouses from the measurement and control devices 300A and 300B. Further, the information processing server 100 acquires the position information relating to the greenhouses 3A and 3B from the GPS terminals 500A and 500B, or from the information processing terminal 200. In addition, the information processing server 100 acquires the meteorological observation information from the meteorological information server 400. Furthermore, the information processing server 100 performs machine learning of the greenhouse environment prediction model on the basis of the extra-atmospheric solar irradiance calculated from the position information of the greenhouses 3A and 3B, the meteorological observation information, and the actual result information relating to the environment inside the greenhouses.

In this way, by employing the machine-learned greenhouse environment prediction model, the future environment inside the greenhouses can be predicted simply by inputting the extra-atmospheric solar irradiance and the meteorological predicted information. Including the extra-atmospheric solar irradiance in the machine learning input enables the prediction accuracy of the environment inside the greenhouses to be improved.

It should be noted that the present invention is not limited to predictions of the environment inside a greenhouse, and can similarly be implemented for open-field cultivation.

The extra-atmospheric solar irradiance may be calculated by inputting, from the information processing terminal, information relating to the latitude and longitude of the open field 3C in which the crop is cultivated, or by acquiring the position information from the GPS terminal 500C, and machine learning of the open-field environment prediction model may be performed on the basis of the extra-atmospheric solar irradiance, the meteorological observation information, and the actual result information relating to the environment in the open field 3C.

In the following description, the present invention can similarly be implemented for open-field cultivation by substituting “greenhouse” and “inside the greenhouse” with “open field”, and substituting “greenhouse environment prediction model” with “open-field environment prediction model”.

Further, the functions of the information processing server 100 may be implemented using a plurality of devices.

For example, the functions of the information processing server 100 discussed hereinabove may be implemented by means of cloud computing including a plurality of devices. Further, an example in which the information processing terminal 200 is a mobile communication terminal such as a smartphone has been described using FIG. 1, but the information processing terminal 200 may be an information communicating device such as a stationary personal computer.

### 2. Embodiment of the Present Invention

A summary of the information processing system 1 according to an embodiment of the present invention has been described hereinabove. The details of the information processing system 1 according to the embodiment of the present invention will next be described.

### 2.1. System Configuration

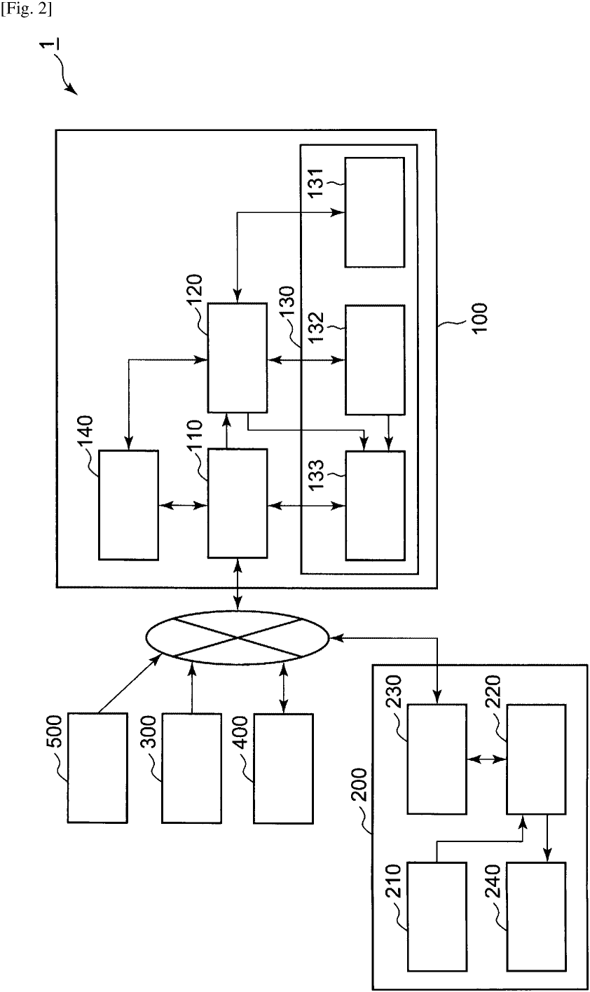

The functional configuration of the information processing system 1 will first be described with reference to FIG. 2. FIG. 2 is a schematic block diagram illustrating an example of the functional configuration of the information processing system 1 according to the embodiment of the present invention.

As illustrated in FIG. 2, the information processing system 1 is provided with the information processing server 100, the information processing terminal 200, and the measurement and control devices 300. The information processing server 100, the information processing terminal 200, and the measurement and control devices 300, and the meteorological information server 400 and the GPS terminals 500, discussed hereinafter, are connected to one another by way of a communication network. These devices are connected by way of a WAN (Wide Area Network) such as the internet.

### Information Processing Server

The information processing server 100 operates as an information processing device, and is provided with a communication unit 110, the storage unit 120, a control unit 130, and the extra-atmospheric solar irradiance calculating unit 140.

### Communication Unit

The communication unit 110 communicates with the information processing terminal 200, the measurement and control devices 300, the meteorological information server 400, and the GPS terminals 500. More specifically, the communication unit 110 receives the actual result information relating to the environment inside the greenhouses from the measurement and control devices 300, receives the meteorological information from the meteorological information server 400, and receives the position information of the greenhouses from the GPS terminals 500. Further, the communication unit 110 transmits information output by an output control unit 133. The communication unit 110 may, for example, transmit the predicted information relating to the environment inside the greenhouses 3A and 3B to the information processing terminal 200 or to the measurement and control devices 300.

The communication unit 110 is realised by means of a communication interface for connecting to the network, for example.

### Storage Unit

The storage unit 120 stores information relating to processing performed by the control unit 130. More specifically, the storage unit 120 stores information received by the communication unit 110 (for example, the actual result information relating to the environment inside the greenhouses 3A and 3B, the meteorological information, and the position information of the greenhouses). Further, the storage unit 120 stores the greenhouse environment prediction model.

The storage unit 120 is realised, for example, by means a storage device for storing data.

### Extra-Atmospheric Solar Irradiance Calculating Unit

The extra-atmospheric solar irradiance calculating unit 140 acquires the position (latitude, longitude) in which the greenhouses 3A and 3B are situated, from the storage unit 120, to calculate the extra-atmospheric solar irradiance. The extra-atmospheric solar irradiance calculating unit 140 may calculate the extra-atmospheric solar irradiance for a referred time span whenever a predicting unit 132 refers thereto. It is known that within Japan the extra-atmospheric solar irradiance Q can be calculated from formula (1), using an arbitrarily defined latitude (north latitude) Φ0 and longitude (east longitude) λ0. Here, dn is the number of elapsed days from 1st January to the target date for which the extra-atmospheric solar irradiance is to be calculated, and the target time is HH hours MM minutes, in Japan Standard Time (JST). Further, δ is the solar declination on the prediction target date, r is the distance between the centre of the earth and the sun, Eq is the equation of time, and h is the hour angle of the sun when the time is HH hours MM minutes.

$$\text{φ} \left[\text{rad}\right] = \text{φ0} \left[\text{degrees}\right] \times π / 180$$

$$\text{λ} \left[\text{rad}\right] = \text{λ0} \left[\text{degrees}\right] \times π / 180$$

$$\text{φ0=} \text{2} π \left(\text{dn} \left[\text{days}\right] \text{-1}\right) / 365 \left[\text{days}\right]$$

$$\begin{matrix}\text{δ} \left[\text{degrees}\right] \text{=0} \text{.006918-0} \text{.399912cos} \left(\text{φ0}\right) \text{+0} \text{.070257sin} \left(\text{φ0}\right) \text{-} \\ \text{0} \text{.006758cos} \left(\text{2} \text{φ0}\right) \text{+0} \text{.000907sin} \left(\text{2} \text{φ0}\right) \text{-0} \text{.002697cos} \left(3 \text{φ0}\right) + \\ \text{0} \text{.001480sin} \left(3 \text{φ0}\right)\end{matrix}$$

$$\begin{matrix}\text{r} \left[\text{astronomical units}\right] = \\ 1 / \left\{1.000110 + 0.034221 cos \left(\text{φ0}\right) + 0.001280 sin \left(\text{φ0}\right) +\right) \\ \left(0.000719 cos \left(2 \text{φ0}\right) + 0.000077 sin \left(2 \text{φ0}\right)\right\} \hat{} 0.5\end{matrix}$$

$$\begin{matrix}\text{Eq} \left[\text{hours}\right] = \text{0} \text{.000075+0} \text{.001868cos} \left(\text{φ0}\right) \text{-0} \text{.032077sin} \left(\text{φ0}\right) \text{-} \\ \text{0} \text{.014615cos} \left(2 \text{φ0}\right) \text{-0} \text{.040849sin} \left(2 \text{φ0}\right)\end{matrix}$$

$$\text{JST} \left[\text{hours}\right] = \text{HH} \left[\text{hours}\right] + \text{MM} \left[\text{minutes}\right] / 60$$

$$\text{h} \left[\text{hours}\right] = \left(\text{JST-12}\right) π / 12 + \left(\text{λ} \text{-135} π / 180\right) + \text{Eq}$$

$$\text{α} \left[\text{hours}\right] = arcsin \left\{sin \left(\text{φ}\right) sin \left(\text{δ}\right) + cos \left(\text{φ}\right) cos \left(\text{δ}\right) cos \left(\text{h}\right)\right\}$$

$$\text{Q} \left[\text{W} / {\text{m}}^{2}\right] = 1367 \left[\text{W} / {\text{m}}^{2}\right] \times \left(1 / \text{r}\right) \hat{} \left(2\right) \times sin \left(\text{α}\right) \qquad \text{(1)}$$

### Control Unit

The control unit 130 controls the overall operation of the information processing server 100. More specifically, the control unit 130 is provided with a machine learning unit 131, the predicting unit 132, and the output control unit 133, as illustrated in FIG. 2, and has the function of controlling processing relating to the prediction of the environment inside the greenhouses 3A and 3B. The control unit 130 is realised, for example, by means of a control device and an arithmetic processing device comprising a CPU (Central Processing Unit), a ROM (Read Only Memory), a RAM (Random Access Memory), and the like.

### Machine Learning Unit

The machine learning unit 131 performs machine learning of the greenhouse environment prediction model. More specifically, the machine learning unit 131 performs machine learning of the greenhouse environment prediction model on the basis of the actual result information relating to the environment inside the greenhouses 3A and 3B, the meteorological observation information corresponding to the actual result information, and the extra-atmospheric solar irradiance corresponding to the actual result information, stored in the storage unit 120.

Specifically, the machine learning unit 131 acquires, from the storage unit 120, the actual result information relating to the environment inside the greenhouses 3A and 3B in a prescribed period in the past, the meteorological observation information for the prescribed period, and the extra-atmospheric solar irradiance for the prescribed period, calculated from the position information of the greenhouses. Furthermore, the machine learning unit 131 performs machine learning of the greenhouse environment prediction model using teacher data in which the extra-atmospheric solar irradiance and the meteorological observation information serve as inputs, and the actual result information relating to the environment inside the greenhouses 3A and 3B serves as the output. The greenhouse environment prediction model after machine learning is stored in the storage unit 120.

It should be noted that actual values of the temperature, relative humidity, solar irradiance, and rainfall, outside the greenhouses 3A and 3B, can be cited as examples of the meteorological observation information input into the greenhouse environment prediction model. Further, actual values of the temperature and relative humidity inside the greenhouses can be cited as examples of the actual result information relating to the environment inside the greenhouses 3A and 3B. In addition, actual values representing the carbon dioxide concentration or the soil moisture content inside the greenhouses, for example, can be cited as examples of the actual result information relating to the environment inside the greenhouses 3A and 3B.

Further, besides the meteorological observation information discussed hereinabove, information relating to the meteorological observation time (observation target time) may, for example, be used as information input into the greenhouse environment prediction model. Further, the information relating to the observation target time may be information relating to a time span to which the observation target time belongs.

Unlike in a factory, the environment such as the weather inside the greenhouses 3A and 3B, for example the temperature or the humidity, as well as the weather outside the greenhouses 3A and 3B, may vary greatly over one day, depending on the presence or absence of solar radiation, and variations between cold and warm in the morning and evening. Thus, by using information relating to time, such as the time span, as information input into the greenhouse environment prediction model, time-series variations in the environment inside the greenhouses 3A and 3B can be considered. The accuracy with which the environment inside the greenhouses 3A and 3B is predicted can therefore be improved.

Further, the information relating to the meteorological observation target time may be information relating to the month to which the meteorological observation target time belongs. The environment inside the greenhouses 3A and 3B may vary greatly across not only one day, but also depending on the season of the year. Thus, by using information relating to the month to which the observation target time belongs as information input into the greenhouse environment prediction model, time-series variations in the environment inside the greenhouses 3A and 3B over a longer span can be considered. The accuracy with which the environment inside the greenhouses 3A and 3B is predicted can therefore be improved.

Further, identification information for identifying the greenhouses 3A and 3B may, for example, be used as information input into the greenhouse environment prediction model. The environment inside the greenhouse may differ greatly between the plurality of greenhouses 3A and 3B, depending on the construction of the greenhouses 3A and 3B, the presence or absence of a control appliance for controlling the environment inside the greenhouse, provided in the greenhouses 3A and 3B, and the performance thereof, and differences in the positions in which the greenhouses 3A and 3B are situated. Accordingly, by using the identification information for identifying the greenhouses 3A and 3B as information input into the greenhouse environment prediction model, a greenhouse environment prediction model suitable for each greenhouse 3A and 3B can be built.

It should be noted that the greenhouse environment prediction model may be built independently for each greenhouse 3A and 3B. Meanwhile, if the plurality of greenhouses 3A and 3B are densely packed within a predetermined region, the environment such as the weather outside the greenhouses in said predetermined region is often uniform. Consequently, by using the identification information for identifying the greenhouses 3A and 3B as information input into the greenhouse environment prediction model, the environment inside the plurality of greenhouses 3 can be predicted with a sufficiently high accuracy simply by building one common greenhouse environment prediction model.

Hereinafter in this specification, extra-atmospheric solar irradiance information calculated from the latitude and the longitude of the greenhouse installation location, the meteorological observation (prediction) information, information relating to the time, identification information of the greenhouses 3A and 3B, and information relating to environment control appliances, for example, are also referred to as input information. Such input information may be quantitative data or qualitative data. Further, the input information may be continuous data, or discrete data divided into a plurality of levels.

Prediction formulas for the temperature and the relative humidity inside the greenhouses 3A and 3B in the greenhouse environment prediction model may, for example, be represented by formula (1) and formula (2) below.

$${\text{T}}_{\text{in}} {\text{=A}}_{1} \times {\text{T}}_{\text{out}} {}^{3} {\text{+A}}_{2} \times {\text{S+Z}}_{1} \left(\text{t}\right) \qquad \text{(1)}$$

$${\text{H}}_{\text{in}} {\text{=B}}_{1} \times {\text{A}}_{\text{out}} {\text{+B}}_{2} \times {\text{S+Z}}_{2} \left(\text{t}\right) \text{+M} \left(\text{t}\right) \qquad \text{(2)}$$

Here, each variable is defined as follows.
Tᵢₙ: Predicted value of temperature inside greenhouses 3A and 3B
Tₒᵤₜ: Predicted value of temperature outside greenhouses 3A and 3B
S: Predicted value of extra-atmospheric solar irradiance
Z₁(t), Z₂ (t): Variable corresponding to time span to which prediction target time belongs
Hᵢₙ: Predicted value of relative humidity inside greenhouse 3
Hₒᵤₜ: Predicted value of relative humidity outside greenhouse 3
M(t): Variable corresponding to month to which prediction target time belongs

Further, the coefficients A₁, A₂, B₁, and B₂, and the variables Z₁(t), Z₂(t), and M(t) are calculated by performing the machine learning discussed hereinafter, for example.

It should be noted that the machine learning unit 131 may build the greenhouse environment prediction model using a known machine learning model. The machine learning model may be any model capable of being used for machine learning of the greenhouse environment prediction model, from among existing machine learning models. For example, the machine learning model may be a computational model that employs linear regression, a filter such as a Kalman filter, a support vector machine, a random forest, a nearest neighbour method, or a neural network or a Bayesian network such as deep learning.

Further, the machine learning unit 131 may update the greenhouse environment prediction model on the basis of predicted information obtained by means of the predicting unit 132 discussed hereinafter, and the actual result information relating to the environment inside the greenhouses 3A and 3B at the prediction target time corresponding to the predicted information. As a result, the greenhouse environment prediction model can be automatically corrected in accordance with the degree of discrepancy between the predicted information and the actual result information. High accuracy relating to the prediction of the environment inside the greenhouse can therefore be maintained.

Specifically, the machine learning unit 131 can automatically optimise the coefficients and the like of the greenhouse environment prediction model by performing machine learning as appropriate, using the successively-obtained extra-atmospheric solar irradiance and meteorological observation information as input data, and using the successively-obtained actual result information relating to the environment inside the greenhouses 3A and 3B as teacher data. Successively updating the greenhouse environment prediction model using machine learning also makes it possible for predicted information relating to the environment inside the greenhouses 3A and 3B, for a greenhouse into which the prediction system has been newly introduced, to be provided in a shorter time and more accurately than if prediction is performed only on the basis of past actual result information using a linear model or the like.

It should be noted that when machine learning is used to update the greenhouse environment prediction model, the following advantages can be obtained depending on the technique used for the machine learning. For example, a Kalman filter can regularly update the coefficients forming the greenhouse environment prediction model, in consideration of differences between the predicted values of the predicted information and the actual measured values of the actual result information. This makes it possible to cope with variations by day or variations by season. Further, neural networks, for example, can easily cope with non-linear variations (for example, changes to the settings of greenhouse environment control devices such as space heaters), which are difficult to predict using linear models or Kalman filters. These techniques relating to machine learning may be used in combination.

### Predicting Unit

The predicting unit 132 uses the greenhouse environment prediction model to predict the environment inside the greenhouses 3 from the extra-atmospheric solar irradiance and the meteorological predicted information. More specifically, on the basis of the greenhouse environment prediction model stored in the storage unit 120, the extra-atmospheric solar irradiance calculating unit calculated by the extra-atmospheric solar irradiance calculating unit 140, and the meteorological predicted information acquired from the meteorological information server 400, the predicting unit 132 generates predicted information by predicting the environment inside the greenhouses 3A and 3B at a time or in a period corresponding to the extra-atmospheric solar irradiance and the meteorological predicted information.

Specifically, the predicting unit 132 acquires, from the storage unit 120, the extra-atmospheric solar irradiance and the meteorological predicted information for the current time or for a prescribed time or a prescribed period in the future, and the greenhouse environment prediction model already built by the machine learning unit 131. Furthermore, the predicting unit 132 inputs the extra-atmospheric solar irradiance and the meteorological predicted information into the greenhouse environment prediction model, to generate, from the greenhouse environment prediction model, the predicted information relating to the environment inside the greenhouses 3A and 3B for the prescribed time or the prescribed period. The predicted information is stored in the storage unit 120.

It should be noted that the information used in the machine learning performed by the machine learning unit 131 may also be used as information input into the greenhouse environment prediction model for prediction processing by the predicting unit 132. For example, the information relating to the meteorological prediction target time (including the time span and the month), the identification information for identifying the greenhouses 3A and 3B, or the information relating to the environment control appliances may be used. By using these items of information in a combined manner in conjunction with the meteorological predicted information, the accuracy of the predicted information can be further improved.

Further, in the same way as with the actual result information, predicted values of the temperature and the relative humidity inside the greenhouses 3A and 3B, and predicted values of the solar irradiance, for example, can be cited as examples of the predicted information relating to the environment inside the greenhouses 3. In addition, predicted values representing the carbon dioxide concentration, the soil temperature, or the soil moisture content inside the greenhouses 3, for example, can be cited as examples of the predicted information relating to the environment inside the greenhouses 3.

Further, information relating to outbreaks of pests may serve as the predicted information relating to the environment inside the greenhouses 3.

More specifically, the predicting unit 132 acquires past pest outbreak information, cultivation information corresponding to the past pest outbreak information, and a pest outbreak determination model built using machine learning based thereon, from the storage unit. The predicting unit 132 then inputs the cultivation information into the pest outbreak determination model, and generates information relating to a pest outbreak inside the greenhouses 3A and 3B at a prescribed time or in a prescribed period, from the pest outbreak determination model. Here, the cultivation information includes crop information, cultivation area information, pest information, drug information, cultivation area observation information, and meteorological information, for example.

Further, information relating to outbreaks of weeds may serve as the predicted information relating to the environment inside the greenhouses 3.

More specifically, the predicting unit 132 acquires past weed outbreak information, cultivation information corresponding to the past weed outbreak information, and a weed outbreak determination model built using machine learning based thereon, from the storage unit. The predicting unit 132 then inputs the cultivation information into the weed outbreak determination model, and generates information relating to a weed outbreak inside the greenhouses 3A and 3B at a prescribed time or in a prescribed period, from the weed outbreak determination model.

Further, information relating to the yield of an agricultural crop or the quality of the agricultural crop may serve as the predicted information relating to the environment inside the greenhouse 3.

More specifically, the predicting unit 132 acquires the yield or the quality of the agricultural crop in a prescribed period in the past, cultivation information in said prescribed period, and an agricultural crop yield model or an agricultural crop quality model built using machine learning based thereon, from the storage unit. The predicting unit 132 then inputs the cultivation information into each model, and generates information relating to the yield or the quality of the agricultural crop at a prescribed time or in a prescribed period, from the corresponding model.

Further, information relating to a recommended date and time for irrigation (watering), or a recommended amount of irrigation, may serve as the predicted information relating to the environment inside the greenhouse 3.

More specifically, the predicting unit 132 acquires the yield or the quality of the agricultural crop in a prescribed period in the past, cultivation information in said prescribed period, and an agricultural crop yield model or an agricultural crop quality model built using machine learning based thereon, from the storage unit. The predicting unit 132 then inputs the cultivation information into each model, and generates information relating to the yield or the quality of the agricultural crop in a prescribed period, from the corresponding model.

### Output Control Unit

The output control unit 133 has the function of controlling the output of predicted information generated by the predicting unit 132.

For example, the output control unit 133 may generate display information relating to the predicted information. The display information includes, for example, the predicted results of the environment inside the greenhouses 3A and 3B at the prediction target time (including period), obtained by the predicting unit 132, such as predicted values of the temperature, relative humidity, solar irradiance, carbon dioxide concentration, soil temperature, and soil moisture content inside the greenhouses 3. In addition, predicted values of the pest outbreak probability, the crop yield, the crop quality, and the time at which crop irrigation is required are included, for example. More specifically, if provision request information is received by means of the communication unit 110, the output control unit 133 acquires the predicted information for a time or period specified in the provision request information. Furthermore, the output control unit 133 may generate display information by processing the acquired predicted information, and output the generated display information to the communication unit 110. Further, the output control unit 133 may output the acquired predicted information to the communication unit 110 without processing the same into display information.

It should be noted that there is no particular limitation to the output mode of the predicted information of which the output is controlled by the output control unit 133. For example, the output control unit 133 may perform control to output the predicted information using various modes such as characters, sound, oscillation by means of vibrations, or light emission.

### Information Processing Terminal

As illustrated in FIG. 2, the information processing terminal 200 is provided with an operation input unit 210, a control unit 220, a communication unit 230, and a display unit 240.

### Operation Input Unit

The operation input unit 210 has the function of accepting operations with respect to the information processing terminal 200. More specifically, the operation input unit 210 accepts input operations, and generates various types of information in accordance with the accepted operations. The various types of generated information are output to the control unit 220. Here, the various types of information generated by the operation input unit 210 are the provision request information or appliance operating information, for example. The provision request information is information indicating a request to the information processing server 100 to provide the display information. Further, the appliance operating information is information indicating the content of an operation to the environment control appliances in the greenhouses 3 with respect to the measurement and control devices 300. For example, an input screen is displayed by means of the display unit 240, and the various types of information discussed hereinabove are generated by the user performing an operation on the input screen.

Further, the operation input unit 210 accepts an information input of the latitude and longitude of the greenhouses 3A and 3B. Data relating to the latitude and longitude are then transferred via the communication unit 230 to the communication unit 110 and are stored in the storage unit 120. The latitude and longitude data are subsequently called from the extra-atmospheric solar irradiance calculating unit 140, which calculates the extra-atmospheric solar irradiance.

It should be noted that the operation input unit 210 is realised by means of buttons, a keyboard, or a touch panel, for example.

### Control Unit

The control unit 220 controls the overall operation of the information processing terminal 200. More specifically, the control unit 220 controls the operation of the communication unit 230 and the display unit 240. For example, the control unit 220 causes the communication unit 230 to transmit the information generated by the operation input unit 210. Further, the control unit 220 generates image information on the basis of the display information provided from the information processing server 100, and causes an image to be displayed by providing the image information to the display unit 240.

It should be noted that the control unit 220 may, for example, be realised by means of a control device and an arithmetic processing device comprising a CPU, a ROM, a RAM, and the like.

### Communication Unit

The communication unit 230 communicates with the information processing server 100. More specifically, the communication unit 230 transmits the provision request information generated by the operation input unit 210 to the information processing server 100. Further, the communication unit 230 receives the display information from the information processing server 100. It should be noted that the information processing terminal 200 may communicate with the measurement and control devices 300 or the meteorological information server 400 to receive the actual result information relating to the environment inside the greenhouses 3 or the meteorological information, or to transmit the appliance operating information.

It should be noted that the communication unit 230 is realised by means of a communication interface for connecting to the network, for example.

### Display Unit

The display unit 240 displays images on the basis of instructions from the control unit 220. More specifically, the display unit 240 displays an information display screen and an operation input screen on the basis of image information provided from the control unit 220.

It should be noted that the display unit 240 is realised by means of a display device such as a display. Further, the functions of the operation input unit 210 and the display unit 240 may be realised integrally using a touch panel or the like.

### Measurement and Control Device

The measurement and control devices 300 are installed in the greenhouses 3A and 3B, and have functions relating to measurement and control of the environment inside the greenhouses 3A and 3B. Specifically, the measurement and control devices 300 acquire signals from sensors provided inside the greenhouses 3A and 3B, and generate the actual result information relating to the environment inside the greenhouses 3A and 3B.

The communication unit communicates with the information processing server 100 or the information processing terminal 200. For example, the communication unit transmits the generated actual result information relating to the environment inside the greenhouses 3 to the information processing server 100 or to the information processing terminal 200. It should be noted that the communication unit may transmit the actual result information each time the actual result information is generated, or may transmit the actual result information at predetermined time intervals. Further, the communication unit may also transmit information other than the actual result information, for example the identification information for identifying the greenhouses 3A and 3B, and information relating to the environment control appliances. It should be noted that the communication unit is realised by means of a communication interface for connecting to the network, for example.

The control unit generates the actual result information relating to the environment inside the greenhouses 3A and 3B on the basis of the signals generated by the sensors. Further, the control unit may control the environment control appliances on the basis of the predicted information relating to the environment inside the greenhouses 3A and 3B, acquired from the information processing server 100, and the appliance operating information acquired from the information processing terminal 200.

The storage unit stores the actual result information relating to the environment inside the greenhouses 3A and 3B, generated by the control unit, and the predicted information relating to the environment inside the greenhouses 3A and 3B or the appliance operating information, for example, acquired via the communication unit. It should be noted that the storage unit may store the actual signal data generated by the sensors. The storage unit is realised, for example, by means a storage device for storing data.

It should be noted that the sensors provided inside the greenhouses 3A and 3B are sensors such as temperature sensors, humidity sensors, solar radiation sensors, carbon dioxide concentration sensors, soil moisture content sensors, and the like. Further, imaging sensors and moisture content sensors, for example, may be provided as said sensors. Further, the measurement and control devices 300 may be installed inside the greenhouses 3A and 3B, or may be installed outside the greenhouses 3A and 3B.

### Meteorological Prediction Server

The meteorological information server 400 provides meteorological information to an external device. More specifically, when meteorological information is requested by the information processing server 100, the meteorological information server 400 transmits the requested meteorological information to the information processing server 100. The meteorological information is information indicating temperature, humidity, solar irradiance, or rainfall, for example. The meteorological information includes meteorological observation information and meteorological predicted information. Meteorological observation information is meteorological information actually observed at the present time or in the past. Further, meteorological predicted information is predicted future meteorological information.

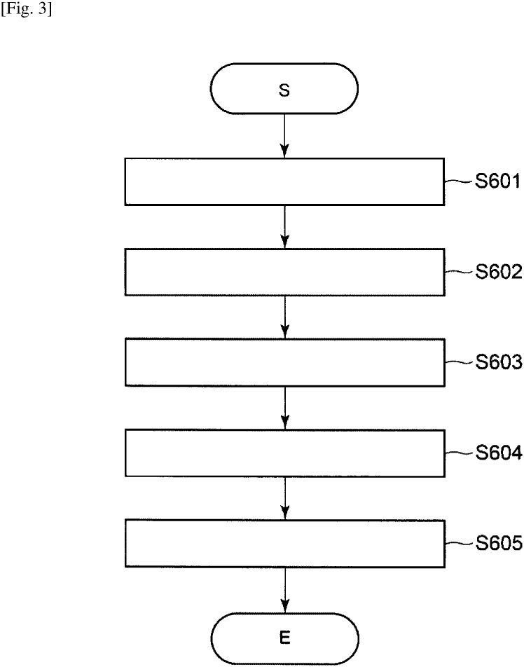

The flow of machine learning processing in the greenhouse environment prediction model will next be described. FIG. 3 is a flowchart that conceptually illustrates an example of machine learning processing in the information processing server 100 according to the embodiment of the present invention.

The information processing server 100 acquires the actual result information relating to the environment inside the greenhouses 3A and 3B, the position information of the greenhouses 3A and 3B, and the meteorological observation information (step S601). More specifically, the actual result information received from the measurement and control device 300, the meteorological observation information received from the meteorological information server 400, and the information relating to the latitude and longitude of the greenhouses 3A and 3B input by means of the information processing terminal 200, or the position information of the greenhouses 3A and 3B received from the GPS terminals 500, are stored in the storage unit 120.

Next, the extra-atmospheric solar irradiance calculating unit 140 acquires, from the storage unit 120, the latitude and longitude information relating to the greenhouses 3A and 3B that has been stored in the storage unit 120, and calculates the extra-atmospheric solar irradiance for a predetermined time or period. The calculated extra-atmospheric solar irradiance is stored in the storage unit 120 (step S602).

Next, the machine learning unit 131 acquires the actual result information relating to the environment inside the greenhouses 3A and 3B, the extra-atmospheric solar irradiance, and the meteorological observation information that have been accumulated in the storage unit 120, and at the same time acquires the greenhouse environment prediction model that is stored in the storage unit 120 (step S603). It should be noted that the greenhouse environment prediction model may have already been trained by means of the machine learning unit 131, or may be untrained.

Next, the information processing server 100 updates the greenhouse environment prediction model using the actual result information relating to the environment inside the greenhouses 3A and 3B, the extra-atmospheric solar irradiance, and the meteorological observation information (step S604). More specifically, the machine learning unit 131 selects one of a plurality of machine learning models, and performs machine learning of the greenhouse environment prediction model using the selected machine learning model, the actual result information relating to the environment inside the greenhouses 3A and 3B, the extra-atmospheric solar irradiance corresponding to the actual result information, and the meteorological observation information corresponding to the actual result information.

At this time, the machine learning unit 131 may perform the machine learning of the greenhouse environment prediction model using, in addition, input information such as information relating to the meteorological observation target time, and the identification information for identifying the greenhouses 3A and 3B, besides the meteorological observation information.

Further, the machine learning unit 131 may input test input data into a new greenhouse environment prediction model obtained by machine learning, and calculate the accuracy of the greenhouse environment prediction model by comparing the output values with test output data.

Next, the information processing server 100 stores the updated greenhouse environment prediction determination model (step S605). More specifically, the machine learning unit 131 causes the storage unit 120 to store the updated greenhouse environment prediction determination model. It should be noted that if the accuracy of the greenhouse environment prediction determination model has been calculated in step S604, the machine learning unit 131 may store the updated greenhouse environment prediction determination model only if the calculated value is at least equal to a predetermined threshold. Further, processing to update the greenhouse environment prediction determination model may be performed once again if the calculated value is less than the predetermined threshold.

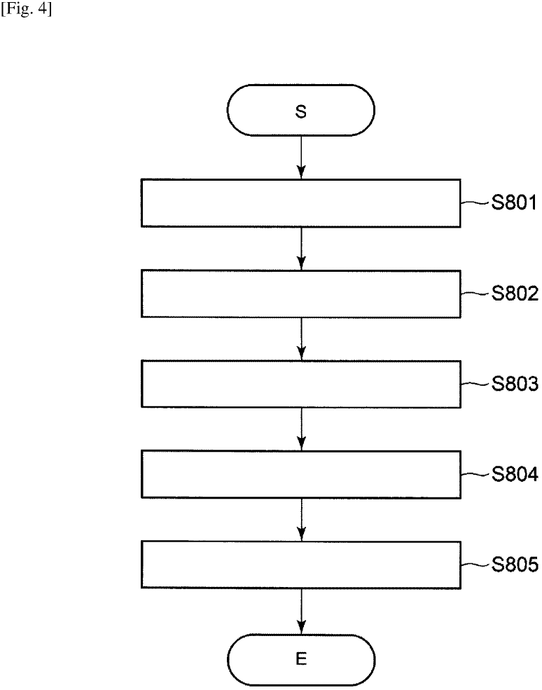

The flow of machine learning processing in the greenhouse environment prediction model will next be described. FIG. 4 is a flowchart that conceptually illustrates an example of prediction processing in the information processing server according to the embodiment of the present invention.

The information processing server 100 sets the greenhouses 3A and 3B that are to be subjected to prediction, and the prediction target time (step S801). More specifically, the predicting unit 132 sets the greenhouses 3A and 3B that are to be subjected to meteorological prediction, and the prediction target time, from the provision request information acquired from the information processing terminal 200.

Next, the information processing server 100 acquires the extra-atmospheric solar irradiance and the meteorological observation information, for example, for the specified prediction target time (step S802). More specifically, the predicting unit 132 acquires the extra-atmospheric solar irradiance and the meteorological observation information for the specified prediction target time, and other input information, from the storage unit 120.

Next, the information processing server 100 acquires the greenhouse environment prediction model (step S803). More specifically, the predicting unit 132 acquires the greenhouse environment prediction model stored in the storage unit 120.

Next, the information processing server 100 uses the greenhouse environment prediction model to generate the predicted information relating to the environment inside the greenhouses 3A and 3B (step S804). More specifically, the predicting unit 132 inputs the extra-atmospheric solar irradiance, the meteorological observation information, and other input information into the greenhouse environment prediction model. The predicting unit 132 then obtains the predicted results from the greenhouse environment prediction model, and generates the predicted information relating to the environment inside the greenhouses 3A and 3B on the basis of the predicted results.

The information processing server 100 then stores the generated predicted information relating to the environment inside the greenhouses 3A and 3B (step S805). More specifically, the predicting unit 132 causes the storage unit 120 to store the generated predicted information.

### 2.3. Summary

As described above, according to the embodiment of the present invention, the information processing server 100 performs machine learning of the greenhouse environment prediction model using the extra-atmospheric solar irradiance and the meteorological observation information as inputs, on the basis of the actual result information relating to the environment inside the greenhouses 3. The information processing server 100 then uses the greenhouse environment prediction model obtained by said machine learning to output the predicted information relating to the environment inside the greenhouses 3A and 3B, from the meteorological predicted information.

Adopting this configuration makes it possible to predict the environment inside the greenhouses 3A and 3B without relying only on meteorological predicted information such as a weather forecast, but also using the extra-atmospheric solar irradiance information. It is therefore possible for accuracy regarding the environment inside the greenhouses 3 to be maintained. Further, employing information relating to the prediction target time (observation target time) and information relating to the greenhouses, besides the extra-atmospheric solar irradiance and the meteorological predicted information, makes it possible to improve prediction accuracy relating to time-series variations in the environment, and therefore relating to the environment inside the greenhouses 3A and 3B.

Further, the greenhouse environment prediction model may be updated, as appropriate, by means of feedback employing the accumulated actual result information and predicted information, in parallel with the prediction processing operation performed by the information processing server 100. As a result, the greenhouse environment prediction model can be automatically improved without human intervention. The time and cost involved in improving the model can thus be reduced, and it is possible to make improvements to the model on the basis of quantitative data.

It should be noted that the generation of the predicted information on the basis of the greenhouse environment prediction model, as discussed hereinabove, can similarly be implemented for open-field cultivation. Installing the measurement and control device 300C, installed in the greenhouse, in the open field in which the crop is being cultivated makes it possible to obtain actual measured values of the environment in the open field. Furthermore, predicted information can be output in the same way as when the invention of the present application is applied to a greenhouse, by performing machine learning of an open-field environment prediction model using, as inputs, the extra-atmospheric solar irradiance calculated on the basis of latitude and longitude information of the open field or position information obtained from the GPS terminal 500C, and meteorological observation information obtained from a meteorological server.

### 4. Conclusion

A preferred embodiment of the present invention has been described in detail hereinabove with reference to the accompanying drawings, but the present invention is not limited to said example. It is obvious that persons having an ordinary level of knowledge in the technical field of the present invention could conceive of various variations or modifications within the scope of the technical concepts recited in the scope of the patent claims, and it is to be understood that these are of course also included within the technical scope of the present invention.

For example, in the embodiment described hereinabove, a description was given of an example in which the information input into the greenhouse environment prediction model is the extra-atmospheric solar irradiance information, the meteorological predicted information, the identification information, and information relating to the environment control appliances, but the present invention is not limited to this example. For example, information obtained from sensors installed outside the greenhouses may be used as information input into the greenhouse environment prediction model. Such sensors may be environmental sensors or the like, and existing sensors may be used. The environmental sensors may include a soil sensor, a rain gauge, a thermometer, or a hygrometer, for example, provided outside the greenhouses.

Further, the steps indicated in the flowchart in the embodiment described hereinabove include, of course, processing that is performed chronologically in the indicated sequence, as well as processing that is not necessarily processed chronologically but can be executed in parallel or individually. Further, it goes without saying that the sequence of the steps that are processed chronologically can in some cases be changed, as appropriate.

Further, a computer program for causing the hardware incorporated into the information processing server 100 to exhibit the same functions as the functional configurations of the information processing server 100 discussed hereinabove can also be created. A storage medium having said computer program stored thereon is also provided.

### EXPLANATION OF THE REFERENCE CODES

1 information processing system, 3A greenhouse, 3B greenhouse, 3C open field, 100 information processing server, 110 computing unit, 120 storage unit, 130 control unit, 131 machine learning unit, 132 predicting unit, 133 output control unit, 140 extra-atmospheric solar irradiance calculating unit, 200 information processing terminal, 210 operation input unit, 220 control unit, 230 communication unit, 240 display unit, 300 measurement and control device, 400 meteorological information server, 500 GPS terminal.

What is claimed is:

1. An information processing device comprising:
an extra-atmospheric solar irradiance calculating unit for calculating extra-atmospheric solar irradiance in each time span on each date at an installation location of a greenhouse in which a crop is cultivated;
a machine learning unit for performing machine learning of a greenhouse environment prediction model on the basis of actual result information relating to an environment inside the greenhouse using the extra-atmospheric solar irradiance and meteorological predicted information as inputs;
a predicting unit for predicting the environment in the greenhouse using the greenhouse environment prediction model; and
an output control unit for controlling the output of predicted information relating to the predicted environment inside the greenhouse.

2. The information processing device according to claim 1, wherein the extra-atmospheric solar irradiance calculating unit calculates the extra-atmospheric solar irradiance on the basis of a latitude and a longitude obtained from an address of the installation location.

3. The information processing device according to claim 1, wherein the information input into the greenhouse environment prediction model includes information relating to the extra-atmospheric solar irradiance at a prediction target time.

4. The information processing device according to claim 1, wherein the predicted information includes information relating to at least one of temperature, humidity, solar irradiance, carbon dioxide concentration, soil temperature, and soil moisture content inside the greenhouse.

5. The information processing device according to claim 1, wherein the predicted information includes information relating to a pest outbreak.

6. The information processing device according to claim 1, wherein the predicted information includes information relating to a weed outbreak.

7. The information processing device according to claim 1, wherein the predicted information includes information relating to at least one of yield of the crop and quality of the crop.

8. The information processing device according to claim 1, wherein the predicted information includes information relating to a date and time at which irrigation of the crop is required, or an amount of required irrigation.

9. An information processing system comprising the information processing device according to claim 1 and at least one measurement and control device in communication with the information processing device, the at least one measurement and control device configured to obtain the actual result information relating to the environment inside the greenhouse.

10. An information processing device comprising:
an extra-atmospheric solar irradiance calculating unit for calculating extra-atmospheric solar irradiance in each time span on each date in an open field in which a crop is cultivated;
a machine learning unit for performing machine learning of an open-field environment prediction model on the basis of actual result information relating to an environment in the open field, using the extra-atmospheric solar irradiance and meteorological predicted information as inputs;
a predicting unit for predicting the environment in the open field using the open-field environment prediction model; and
an output control unit for controlling the output of predicted information relating to the predicted environment in the open field.

11. The information processing device according to claim 10, wherein a position of the open field is identified by means of a latitude and a longitude obtained from an address of the open field.

12. An information processing system comprising the information processing device according to claim 10 and at least one measurement and control device in communication with the information processing device, the at least one measurement and control device configured to obtain the actual result information relating to the environment in the open field.
